(19) United States
(12) Patent Application Publication
(10) Pub. No.: US 2007/0096370 A1
(43) Pub. Date: May 3, 2007

(54) Manufacturing method of producing ceramic honeycomb structure body

(75) Inventor: Hiromasa Aoki, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/589,756

(22) Filed: Oct. 31, 2006

(30) Foreign Application Priority Data
Nov. 1, 2005 (JP) 2005-318567

(51) Int. Cl. B28B 11/18; C04B 33/32; B28B 17/00

(52) U.S. Cl. 264/630; 264/162

(57) ABSTRACT

In a manufacturing method of producing ceramic honeycomb structure bodies, an extrusion molding step extrudes a ceramic raw material to make a ceramic honeycomb molded body having an outer peripheral skin part, plural cell walls arranged in a honeycomb structure shape, and plural cells surrounded by the cell walls. A cutting step cuts the ceramic honeycomb molded body into plural ceramic honeycomb shaped bodies of a predetermined length. A drying step dries each ceramic honeycomb shaped body, and a working step cuts and removes the outer peripheral part thereof. A burning step burns the worked ceramic honeycomb shaped bodies to produce the ceramic honeycomb structure bodies. In the working step, a cutting tool for blanking having a cutting tooth formed at a front part thereof is relatively moved in the axis direction of the ceramic honeycomb shaped body in order to cut and remove the outer peripheral part including at lease the outer peripheral skin part.

### CROSS-REFERENCE TO RELATED APPLICATIONS

This application is related to and claims priority from Japanese Patent Application No. 2005-318567 filed on Nov. 1, 2005, the contents of which are hereby incorporated by reference.

### BACKGROUND OF THE INVENTION

1. Field of the Invention

The present invention relates to a manufacturing method of producing ceramic honeycomb structure bodies, each composed of a plurality of cells arranged in a honeycomb structure shape to be used as catalyst carriers for purifying exhaust gases emitted from an internal combustion engine of a vehicle.

2. Description of the Related Art

Traditionally, a ceramic honeycomb structure body is used as a catalyst carrier and an exhaust gas purifying filter mounted on an exhaust gas purifying apparatus for an internal combustion engine of a vehicle.

Such a ceramic honeycomb structure body has a plurality of cells arranged in a honeycomb structure shape. Each of the plural cells is surrounded by a corresponding cell wall. The ceramic honeycomb structure body is produced by a manufacturing method comprising an extrusion molding step, a cutting step, a drying step, and a burning (or firing) step. In the extrusion molding step, a ceramic raw material is extruded and molded in order to produce a ceramic honeycomb molded body. In the cutting step, the ceramic honeycomb molded body is cut into a plurality of ceramic honeycomb shaped bodies, each of which has a predetermined length. The ceramic honeycomb shaped bodies are then dried in the drying step, and burned (or fired) in the burning step.

Such a conventional manufacturing method firstly performs the extrusion molding in order to extrude and mold the ceramic honeycomb molded body having a honeycomb structure shape as a finally-obtained shape version. However, it is difficult for the extrusion molding step of the conventional manufacturing method to extrude and mold of a complicated shape of the ceramic honeycomb structure body. Even if the conventional manufacturing method produces a specified shape of a ceramic honeycomb structure body, there is a possibility of causing a deformation or of a crack appearing in the ceramic honeycomb structure body after carrying out various working steps and thereby a possibility of decreasing the dimensional precision of the ceramic honeycomb structure body finally produced.

In order to avoid the problems described above, for example, Japanese patent laid open publication JP 2001-191240 has disclosed an improved conventional manufacturing method that produces a ceramic honeycomb structure body in which a fired ceramic honeycomb structure body after the burning step is cut and grinded by using a cutting tool made of grind stones therein. Further, another conventional technique, for example, Japanese patent JP 2604876 (which corresponds to its family U.S. Pat. No. 5,188,779) has disclosed a manufacturing method of working a ceramic honeycomb fired body after the burning step by a grinding stone and the like.

However, both of the above conventional manufacturing methods involve the possibility of causing deformation or a crack to appear in the ceramic honeycomb structure body (namely, a ceramic honeycomb fired body) when cutting, grinding, and working steps are carried out because they use the ceramic honeycomb fired bodies after the burning step. Accordingly, a manufacturing method of a ceramic honeycomb structure body is in demand for easily producing a specified shape of ceramic honeycomb structure bodies with a highly precise dimension.

### SUMMARY OF THE INVENTION

The present invention is designed to address the above mentioned conventional drawback and prior art deficiencies. It is an object of the present invention to provide a manufacturing method easily producing a specified shape of the ceramic honeycomb structure body with a highly precise dimension.

According to an aspect of the present invention, there is provided a manufacturing method of producing a ceramic honeycomb structure body, having steps of an extrusion molding, a cutting, a drying, a working, and a burning.

The extrusion molding step extrudes ceramic raw material to mold a ceramic honeycomb molded body composed of an outer peripheral skin part, cell walls arranged in the outer peripheral skin part in a honeycomb structure shape, and a plurality of cells surrounded by the cell walls. Each cell has a penetrate hole, penetrating both ends of the ceramic honeycomb molded body, formed along the axis direction of the ceramic honeycomb molded body. The cutting step cuts the ceramic honeycomb molded body into a plurality of ceramic honeycomb shaped bodies of a specified length. The drying step dries the ceramic honeycomb shaped body. The working step cuts out and removes the outer peripheral surface including the outer peripheral skin part of the ceramic honeycomb shaped body by using cutting means. The cutting means has a cutting tooth formed at a front part of the cutting tool while relatively moving the cutting tool in the axis direction of the ceramic honeycomb shaped bodies. The burning step burns the worked ceramic honeycomb shaped body.

In the manufacturing method of the present invention, the working step is carried out after the drying step. In the working step, the outer peripheral part including the outer peripheral skin part of the ceramic honeycomb shaped body is cut and removed by relatively moving the cutting means having the cutting tooth formed at the front part thereof in the axis direction of the ceramic honeycomb shaped body. That is, because the working step works the ceramic honeycomb shaped body after the completion of the drying step and before the initiation of the burning step, it is possible to easily work a specified shape of the ceramic honeycomb shaped body with the cutting means of a simple configuration. It is thereby possible to increase the dimensional precision of the ceramic honeycomb structure body finally produced.

In addition, because the working step cuts and removes the outer peripheral part including at least the outer peripheral skin part of the ceramic honeycomb shaped body, the following burning step burns the ceramic honeycomb shaped body from which the outer peripheral skin part has been removed. It is thereby possible to suppress the occurrence of deformation and cracks to be caused during the burning step and to increase the dimensional accuracy of the ceramic honeycomb structure body finally produced. Further, because the rising rate of the burning temperature during the burning step can be increased and the time length of the temperature rising can be also reduced. This can increase the manufacturing efficiency to produce the ceramic honeycomb structure body.

Further, the extrusion molding step extrudes the ceramic honeycomb molded body having the outer peripheral skin part. The working step then cuts and removes at least the outer peripheral skin part from the ceramic honeycomb shaped body in order to obtain the worked ceramic honeycomb shaped body. This means that it is not necessary for the extrusion molding step to make the finally-produced shape of the ceramic honeycomb structure body. In other words, the extrusion molding step can easily and freely make the shape of the ceramic honeycomb molded body in a rough dimension so long as the following working step can work the ceramic honeycomb shaped body having the finally produced shape of the ceramic honeycomb structure body. The extrusion molding step can provide the ceramic honeycomb shaped body of a more simple shape, and this can thereby increase the manufacturing productivity of the ceramic honeycomb structure body.

Still further, when the manufacturing method finally produced plural types of the ceramic honeycomb structure bodies having an approximately same size and different shapes, it is not necessary to prepare plural types of ceramic honeycomb shaped bodies, but only to prepare one type of the ceramic honeycomb shaped body, because the working step only works one type of the ceramic honeycomb shaped body and then makes plural types of the ceramic honeycomb shaped bodies corresponding to the specified shapes of the ceramic honeycomb structure body finally produced. This can also increase the manufacturing productivity.

Still further, in the steps before the working step, namely, in the extrusion molding step, the cutting step, and the drying step, even if deformation or cracks occur in the outer peripheral skin part, because the working step cuts and removes the outer peripheral skin part from the ceramic honeycomb shaped body in order to make a specified shape of the ceramic honeycomb shaped body. This can provide the ceramic honeycomb structure body with high accuracy.

According to the present invention as described above, it is possible to provide the manufacturing method capable of easily producing the specified shape of the ceramic honeycomb structure body.

According to another aspect of the present invention, there is provided the manufacturing method in which, in particular, the cutting means to be used in the working step is a rotary cutting tool. The rotary cutting tool is composed of a base body and one of cutting member and grinding member formed on the outer peripheral surface of the base body. The rotary cutting tool is placed on the ceramic honeycomb shaped body to be worked so that the rotary cutting tool and the ceramic honeycomb shaped body are in a twisted position each other. The working step uses the rotary cutting tool while rotatably moving the rotary cutting tool on the ceramic honeycomb shaped body.

In the manufacturing method of producing a ceramic honeycomb structure body as another aspect of the present invention, the working step is carried out after the completion of the drying step, in which the rotary cutting tool as the cutting means is placed on the ceramic honeycomb shaped body to be worked so that the rotary cutting tool and the ceramic honeycomb shaped body are in a twisted position each other, and then cuts and removes the outer peripheral part of the ceramic honeycomb shaped body while rotatably moved in the axis direction of the ceramic honeycomb shaped body. That is, the rotary cutting tool and the axis direction of the ceramic honeycomb shaped body are not in a same plane, but in a twisted position to each other. This relative position of the rotary cutting tool and the ceramic honeycomb shaped body can prevent to supply the stress to the peripheral direction of the ceramic honeycomb shaped body, namely, to the direction to which the cell walls fall down, and thereby obtain the high dimensional accuracy. In addition to this feature, the manufacturing method as another aspect of the present invention can obtain the same action and effects of the previous manufacturing method.

Accordingly, the present invention is capable of providing the manufacturing method of easily producing the ceramic honeycomb structure body of a specified shape with a high dimensional accuracy.

In particular, the cutting means to be used in the working step is a cutting tool for blanking. The cutting tool has a cutting tooth of a circular shape and whose cross section in its circumference direction corresponds to the specified shape of the ceramic honeycomb structure body. In the working step, the cutting tool cuts and removes the outer peripheral part of the ceramic honeycomb shaped body. In this case, it is possible to easily work a specified shape of the ceramic honeycomb shaped body after the drying step and thereby possible to increase the dimensional accuracy of the ceramic honeycomb structure body after the burning step.

Further, it is possible to work the ceramic honeycomb shaped body by the simple operation of blanking the ceramic honeycomb shaped body by using the cutting tool for blanking. This can increase the manufacturing productivity.

Still further, by setting in advance the shape of the cross section in the circumferential direction of the cutting tooth of the cutting tool for blanking, it is possible to easily work various cross-sectional shapes of the ceramic honeycomb shaped body such as an oval shaped cross section, a race-track shaped cross section, a triangle shaped cross section, and a polygonal shaped or an optional asymmetric shaped cross section of the ceramic honeycomb shaped body. This can produce various cross-sectional shaped of the ceramic honeycomb structure bodies easily.

Further, the cutting means to be used in the working step is a cutting tool having a cutting tooth of one of a straight line shape and a curved line shape. It is preferred for the cutting tool to cut out and to remove the outer peripheral part of the ceramic honeycomb shaped body during the working step. In this case, it is possible to easily work a specified shape of the ceramic honeycomb shaped body, and thereby to increase the dimensional accuracy of the ceramic honeycomb structure body produced after the burning step.

Still further, it is preferred to carry out the working step while arranging a plurality of the cutting tools on the peripheral part of the ceramic honeycomb structure body. This can work the ceramic honeycomb shaped body efficiently, and thereby to increase the manufacturing efficiency to produce the ceramic honeycomb structure body.

Still further, it is preferred that a clearance angle β at a front part of the cutting means to be used in the working step is within a range of more than 0° to not more than 10° (0°<β<=10°). In the condition of the clearance angle β of more than 10°, because a stress to be applied to the front part of the cutting tooth toward the inside of the ceramic honeycomb shaped body becomes increased when the ceramic honeycomb shaped body is worked, elastic deformation and plastic deformation arise at the front part of the cutting tooth of the cutting tool, there is a possibility of decreasing the dimensional accuracy and the precision of the cross-sectional shape of the ceramic honeycomb shaped body. In addition, there is a possibility of drastically decreasing the wear resistance at the front part of the cutting tooth of the cutting tool and to break the front part thereof.

Moreover, it is possible that a clearance angle β at a front part of the cutting tool to be used in the working step is zero (β=0°). This can work a specified shape of the ceramic honeycomb shaped body without causing any problem.

Still moreover, it is preferred that a cross section of a cutting tooth in the cutting tool for blanking to be used in the working step in its circumference direction is a circular shape, and the cutting tool satisfies that a parameter L/2d is within a range of 0.05 to 0.15 (0.05<=L/2d<=0.15), where L is a length of a straight shaped part of the cutting tool having the clearance angle β=0° of the front part, and d is a radius of the front part.

If the parameter L/2d is less than 0.05, (L/2d<0.05), it is impossible to obtain an adequate strength of the front part of the cutting tooth. This causes elastic deformation and plastic deformation at the front part of the cutting tooth of the cutting tool, and thereby causes a possibility of decreasing the dimensional precision and the precision of the cross sectional shape of the ceramic honeycomb shaped body during the working step. In addition, this leads to a possibility of decreasing the wear resistance at the front part of the cutting tooth and to break this front part.

On the contrary, if the parameter L/2d exceeds 0.15, the cutting tooth of the cutting tool contacts the outer peripheral part of the ceramic honeycomb shaped body during the working step. This leads to a possibility of breaking the ceramic honeycomb shaped body.

Furthermore, it is preferred that an included angle α at a tip of the cutting tooth to be used in the working step is within a range of 5° to 55° (5°<=α<=55°).

If the included angle α at the tip of the cutting tooth is less than 5° (α<5°), it is impossible to obtain an adequate strength of the front part of the cutting tooth. While the ceramic honeycomb shaped body is worked in the working step, there leads a possibility of causing elastic deformation and plastic deformation at the front part of the cutting tooth, and thereby to decrease the dimensional precision and the precision of the cross sectional shape of the ceramic honeycomb shaped body. In addition, this leads to a possibility of decreasing the wear resistance at the front part of the cutting tooth and to break this front part.

On the contrary, if the included angle α at the tip of the cutting tooth is more than 55° (α>55°), this can cause a possibility of breaking the ceramic honeycomb shaped body at a more front part thereof than the position of the front part of the cutting tooth when the cutting tooth contacts and cuts the ceramic honeycomb shaped body. This leads to a possibility of being able to work the ceramic honeycomb shaped body more precisely.

Here, the included angle (or the nose angle) α means the angle at the front part of the cutting tool (as cutting means), and the clearance angle (or the angle of relief) β means the angle between the inner surface of the front part and the moving direction (or a blanking direction, or a cutting direction) of the cutting tooth.

Further, it is preferred that the cutting means is relatively moved in the axis direction and the circumference direction of the ceramic honeycomb shaped body while vibrating the cutting means. This can work the ceramic honeycomb shaped body efficiently with high accuracy.

Still further, it is preferred that the cutting means is vibrated by an ultrasonic vibration apparatus while the working step is carried out. This can also work the ceramic honeycomb shaped body efficiently with high accuracy.

Moreover, it is preferred that the rotary cutting tool composed of the cutting member having a plurality of cutting teeth. This can work the ceramic honeycomb shaped body after the drying step with high accuracy, and it is thereby possible to increase the dimensional accuracy of the ceramic honeycomb structure body after the burning step.

In addition, it is preferred that the rotary cutting tool composed of the grinding member having grinding stones. This can also work the ceramic honeycomb shaped body after the drying step with high accuracy, and thereby possible to increase the dimensional accuracy of the ceramic honeycomb structure body after the burning step.

Furthermore, it is preferred that the plural rotary cutting tools are placed on the outer peripheral surface of the ceramic honeycomb shaped body. This can work the ceramic honeycomb shaped body efficiently, and thereby possible to increase the manufacturing productivity of the ceramic honeycomb structure body.

Still furthermore, it is preferred that the outer peripheral part of the ceramic honeycomb shaped body is cut and removed by the rotary cutting tool rotatably moved in the axis direction of the ceramic honeycomb shaped body while rotating the ceramic honeycomb shaped body. This can also work the ceramic honeycomb shaped body efficiently, and it is thereby possible to further increase the manufacturing productivity of the ceramic honeycomb structure body.

Still furthermore, it is preferred that after the completion of the working step, the outer peripheral surface of the worked ceramic honeycomb shaped body obtained by the working step is coated with an outer skin material, and the burning step is performed for making a new outer skin part on the fired ceramic honeycomb shaped body. In addition, it is possible to coat the outer peripheral surface of the fired ceramic honeycomb shaped body with outer skin material after the completion of the burning step, and to burn or dry it in order to form a newly outer skin part on the ceramic honeycomb shaped body. This can prevent any deformation from occurring and breaking the cell walls formed at the outer peripheral part of the ceramic honeycomb structure body during the transportation and assembling of the ceramic honeycomb structure body. In addition, it is possible to increase the isostatics strength of the ceramic honeycomb structure body

Still furthermore, it is preferred that the cutting tooth of the cutting means is made of high strength material such as sintered hard alloy, high speed steel, and die steel and further preferred that the surface treatment is performed for the cutting tooth which is coated with Ti—N or Cr—N. This can improve the wear resistance and the lifetime of the cutting tooth.

### BRIEF DESCRIPTION OF THE DRAWINGS

A preferred, non-limiting embodiment of the present invention will be described by way of example with reference to the accompanying drawings, in which:

FIG. 1 is a schematic view of a ceramic honeycomb shaped body produced by a manufacturing method according to a first embodiment of the present invention;

FIG. 2 is a perspective view showing a cutting tool for blanking to be use in a working step in the manufacturing method of the first embodiment of the present invention;

FIG. 3 is a sectional enlarged view showing a tip of the cutting tool shown in FIG. 2;

FIG. 4A, FIG. 4B, and FIG. 4C are views showing a blanking flow of the ceramic honeycomb shaped body performed in the working step by using the cutting tool shown in FIG. 2 and FIG. 3;

FIG. 5 is a perspective view of a ceramic honeycomb structure body produced by the manufacturing method according to the first embodiment;

FIG. 6 is a sectional enlarged view showing another shape of a front part of the cutting tool for use in blanking shown in FIG. 2;

FIG. 7A to FIG. 7D are sectional views showing various cross sections of the ceramic honeycomb shaped body in a circumference direction after the completion of the working step using the cutting tool in the manufacturing method of the first embodiment;

FIG. 8 is a perspective view showing a part of a structure of a cutting tool to be used in the working step in the manufacturing method according to the second embodiment of the present invention;

FIG. 9 is a perspective view showing a structure of a rotary cutting tool to be used in the working step in the manufacturing method according to the third embodiment of the present invention; and

FIG. 10 is a schematic view showing cutting a ceramic honeycomb shaped body in the working step by using the rotary cutting tool shown in FIG. 9.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

First Embodiment

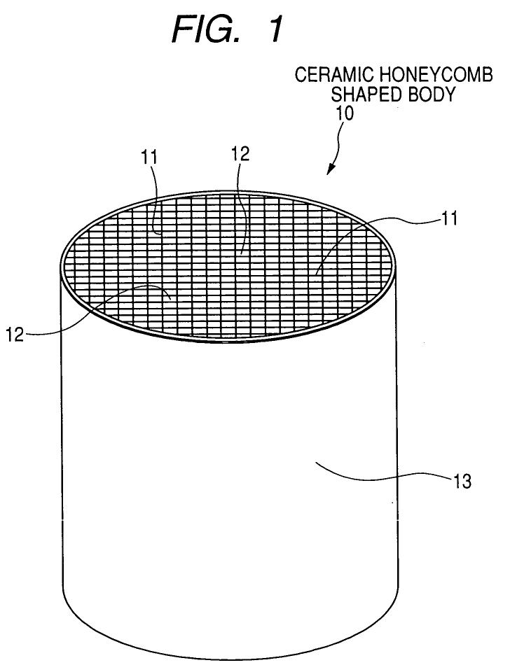

A description will be given of the manufacturing method of producing a ceramic honeycomb structure body according to the first embodiment of the present invention with reference to FIG. 1 to FIG. 5.

As shown in FIG. 1 to FIG. 5, the manufacturing method according to the first embodiment has the steps of an extrusion molding, a cutting, a drying, a working, and a burning.

In the extrusion molding step, a ceramic raw material is extruded to produce a ceramic honeycomb molded body. The ceramic honeycomb molded body has an outer peripheral skin part 13, a plurality of cell walls 11 formed, in a honeycomb structure shape, in the inside area of the outer peripheral skin part 13, and a plurality of cells 12 surrounded by the plural cell walls 11. Each of the cells is a penetrate hole formed along a longitudinal direction or an axis direction of the ceramic honeycomb molded body.

In the cutting step, the ceramic honeycomb molded body is cut into a plurality of ceramic honeycomb shaped bodies, and each ceramic honeycomb shaped body 10 has a predetermined length.

In the drying step, the ceramic honeycomb shaped bodies 10 are dried.

In the working step, the outer peripheral part of the dried ceramic honeycomb shaped body 10 is worked and removed.

In the burning step, the worked ceramic honeycomb shaped body 10 is burned or fired.

In particular, the working step in the manufacturing method of the first embodiment uses a cutting tool 2 (as cutting means) for use in blanking having a cutting tooth 21 at the tip of the cutting tool 2. In the working step, the cutting tool 2 for blanking is relatively shifted toward the axis direction of the ceramic honeycomb shaped body 10 in order to remove at least the outer peripheral part of the ceramic honeycomb shaped body 10. Hereinafter, various steps, in particular, the working step will be explained in detail.

<Extrusion Molding Step and Cutting Step>

Firstly, water, methyl cellulose, and pore forming agent of a predetermined amount are added into ceramic raw material powders, and the ceramic raw material powders are then mixed together in order to make a ceramic raw material.

The ceramic raw material is composed mainly of cordierite including kaolin, fused silica, and aluminum hydroxide, alumina, talc, carbon particles, and the like which are mixed in optimum proportions. The chemical composition of the cordierite is SiO₂: 45.0 to 55.0 wt %, Al₂O₃: 33.0 to 42.0 wt % , and MgO: 12.0 to 18.0 wt %.

Next, in the extrusion molding step, the ceramic raw material is extruded by using an extrusion die (not shown) in order to produce a ceramic honeycomb molded body. In the cutting step, the ceramic honeycomb molded body is cut into a plurality of ceramic honeycomb shaped bodies 10, and each has a predetermined length.

FIG. 1 is a schematic view of the ceramic honeycomb shaped body 10 produced by the manufacturing method according to the first embodiment of the present invention. As shown in FIG. 1, the ceramic honeycomb shaped body 10 has a cylindrical shape of a predetermined length. Each ceramic honeycomb shaped body 10 has the plural cell walls 11 that are arranged in a honeycomb structure shape, the plural cells 12 surrounded by the cell walls 12, and the outer peripheral skin part 13. Each cell 12 is a through hole that penetrates the ceramic honeycomb shaped body 10 along the axis direction thereof. The outer peripheral skin part 13 is formed on the outer surface of the ceramic honeycomb shaped body 10.

<Drying Step>

Next, the ceramic honeycomb shaped body 10 is dried until a moisture content of the ceramic honeycomb shaped body 10 becomes a predetermined percentage or less by a microwave heating or a high frequency wave heating.

<Working Step>

A description will now be given of the structure of the cutting tool to be used in the working step.

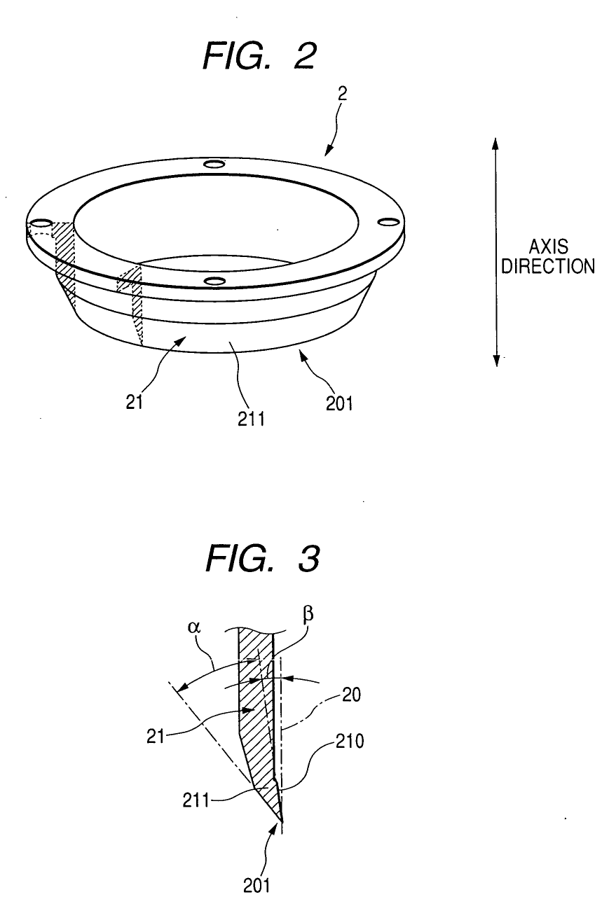

FIG. 2 is a view showing the cutting tool 2 for blanking to be used in the working step in the manufacturing method according to the first embodiment of the present invention, and FIG. 3 is a sectional enlarged view showing a tip 201 of the cutting tool 2 for blanking shown in FIG. 2;

The cutting tool 2 to be used for blanking has a cylindrical shape and made of high speed steel as a high strength material such as die steel.

The cutting tooth 21 is formed at the tip 201 of the cutting tool 2 for blanking. The cutting tooth 21 has an acute shape in its axis direction and a ring shape or circular part in its circumferential direction.

A cross section in the circumferential direction of the front part 211 of the cutting tool 2 has a same shape of the cross section of the ceramic honeycomb structure body 1 finally produced. In the first embodiment, the cross section of the shape of the finally produced ceramic honeycomb structure body 1 is a cylindrical shape.

By the way, there is a possibility of causing wear between the front part 211 of the cutting tool 2 and the ceramic raw material of the ceramic honeycomb shaped body 10 to be worked. In order to avoid such a wear and to increase a wear resistance capability of the cutting tool 2, the cutting tooth 21 thereof is processed by heat treatment for a specified time or performed by a surface treatment to coat the surface of the front part 211 with a ceramic coating material such as Ti—N or Cr—N. This treatment can increase the hardness of the front part 211 of the cutting tool 2, and thereby increases the lifetime of the cutting tooth 21 of the cutting tool 2.

Further, in order to avoid adhesion of broken pieces or cutting powders removed from the ceramic honeycomb shaped body 10, it is preferred to perform a fine dimple processing to the surface of the cutting tooth 21 of the cutting tool 2.

Still further, it is preferred to remove such broken pieces or cutting powder by vibrating the cutting tooth 21 of the cutting tool 2 by a force other than the working force added in the working step, or by using a powerful and positive removing means such as a brush.

As shown in FIG. 3, an included angle (or a nose angle) α of the front part 211 of the cutting tool 2 is 25°, and a clearance angle (or an angle of relief) β of the front part 211 of the cutting tool 2 is 3°. As clearly shown in FIG. 3 and through the entire description, the included angle (or the nose angle) α means the angle at the front part 211 of the cutting tool 2, and the clearance angle (or the angle of relief) β means the angle between the inner surface 210 of the front part 211 and the moving direction 20 (or a blanking direction) of the cutting tooth 21.

It is preferred to have the following equations (1) and (2) of the dimensional relationship between the ceramic honeycomb shaped body 10 and the cutting tool 2 for blanking when each cross section in a circumferential direction of the honeycomb shaped body 10 and the cutting tooth 21 of the cutting tool 2 for blanking has a simple cylindrical shape,
D>=2d+2t (1), and
D<=2d+6s (2),

where “D” is an outer diameter of the ceramic honeycomb shaped body 10, “t” is a thickness of the outer peripheral skin part 13, “s” is a cell pitch, and “d” is a radius at the front part 211 of the cutting tool 2.

Based on the above relationship determined by the equations (1) and (2), it is possible to work the ceramic honeycomb shaped body 10 with high accuracy.

The working step performs the blanking of the honeycomb shaped body 10 by using the cutting tool 2.

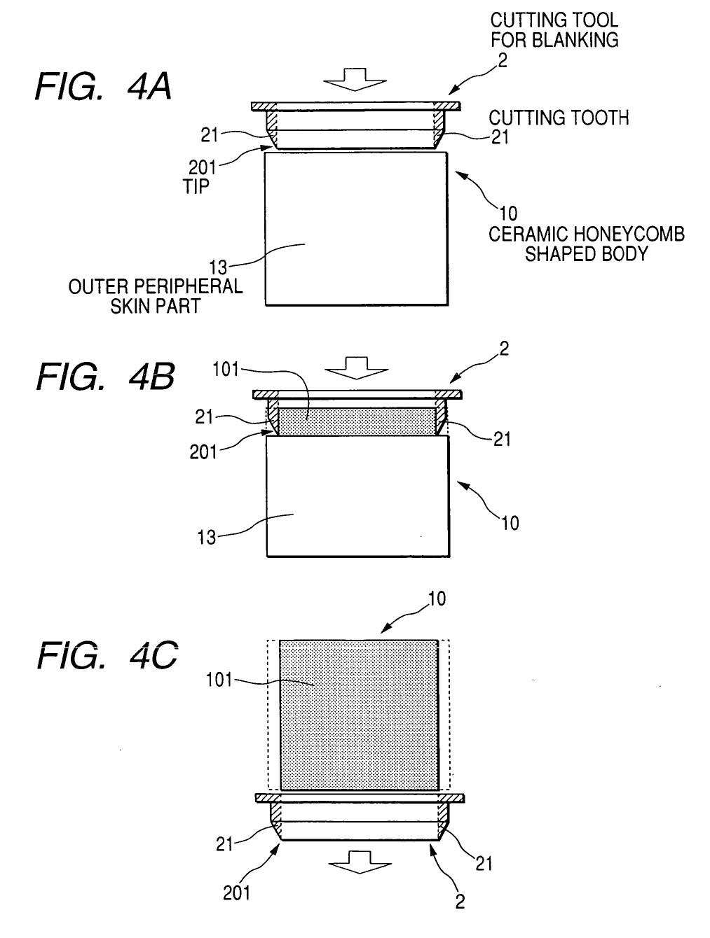

FIG. 4A, FIG. 4B, and FIG. 4C are views showing the blanking flow of the ceramic honeycomb shaped body 10 performed in the working step by using the cutting tool 2 shown in FIG. 2.

As shown in FIG. 4A, the cutting tool 2 for blanking is firstly set above the ceramic honeycomb shaped body 10 to be processed. At this time, the cutting tool 2 for blanking is so adjusted in position that the cutting tooth 21 is positioned above the circumference part of the ceramic honeycomb shaped body 10 to be worked.

As shown in FIG. 4B, the cutting tool 2 for blanking is moved in the axis direction of the ceramic honeycomb shaped body 10 to be worked. In the first embodiment, the cutting tool 2 for blanking is forcedly vibrated by an ultrasonic vibration apparatus (omitted from the diagrams) while moving it in the axis direction.

While contacting the cutting tooth 21 of the cutting tool 2 to the ceramic honeycomb shaped body 10, the outer peripheral part of the ceramic honeycomb shaped body 10 is gradually cut and removed. After the completion of the blanking, the cell walls 11 are exposed on the worked surface 101 of the ceramic honeycomb shaped body 10. In FIG. 4B and FIG. 4C, the cell walls 11 exposed on the worked surface of the ceramic honeycomb shaped body 10 are omitted for brevity.

As shown in FIG. 4C, when the cutting tool 2 has been moved to the lower position of the ceramic honeycomb shaped body 10, the blanking is completed. The completion of the blanking provides the ceramic honeycomb shaped body 10 of a predetermined shape from which the outer peripheral part including the outer peripheral skin part 13 has been removed.

In order to avoid the occurrence of falling down and breaking the cell walls 11 exposed on the worked surface 101 of the ceramic honeycomb shaped body 10, the blanking is carried out while adjusting the force to be applied to the ceramic honeycomb shaped body 10.

In the above explanation, although the cutting tool 2 is moved and the ceramic honeycomb shaped body 10 is fixed in position while the blanking is carried out, it is acceptable to move only the ceramic honeycomb shaped body 10 and to fix the cutting tool 2, or also acceptable to move both the ceramic honeycomb shaped body 10 and the cutting tool 2.

<Burning Step>

Next, the worked ceramic honeycomb shaped body 10 having a predetermined shape is burned at not less than a temperature at which the cordierite is made therein.

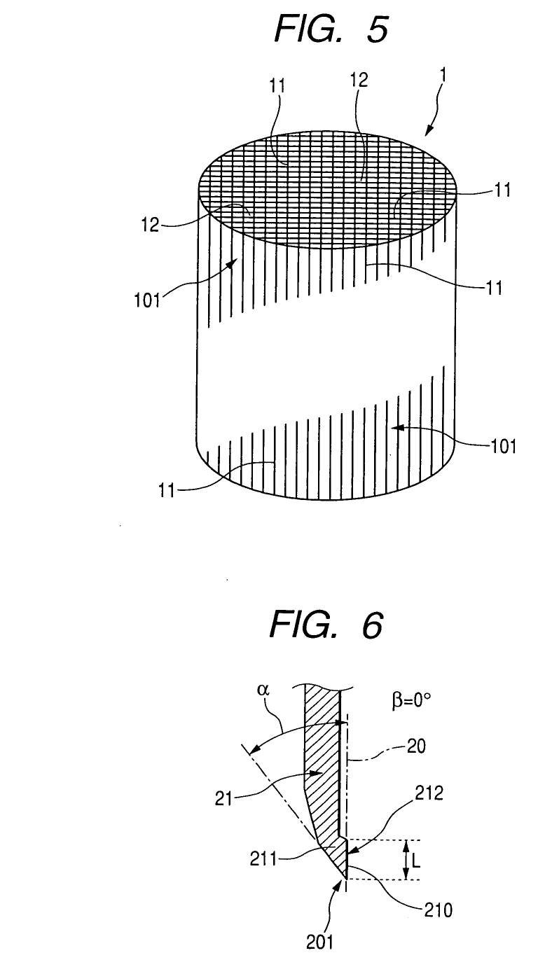

FIG. 5 is a perspective view of the ceramic honeycomb structure body 1 produced by the manufacturing method of the first embodiment.

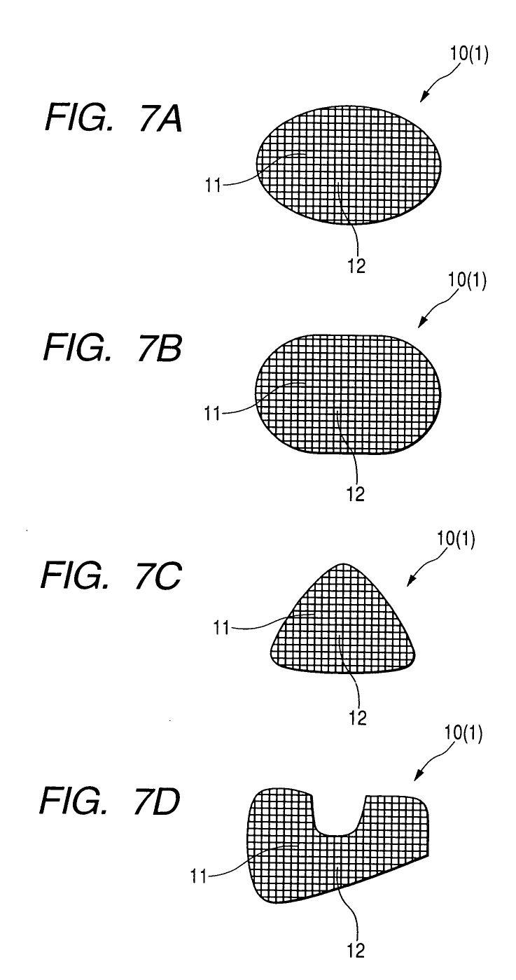

As shown in FIG. 5, the completion of the burning step produces the ceramic honeycomb structure body 1. Some of the cell walls in the produced ceramic honeycomb structure body 1 are exposed on the worked surface, namely, exposed on the outer peripheral surface thereof. FIG. 5 shows the cell walls, by border or profile lines, exposed on the outer peripheral surface of the ceramic honeycomb structure body 1. (FIG. 7A to FIG. 7D also show the cell walls exposed on the outer peripheral surface of the ceramic honeycomb structure body 1 by using border or profile lines.)

Further, it is possible to coat the worked surface of the ceramic honeycomb shaped body 10, namely, the outer surface of the ceramic honeycomb shaped body 10 with a newly outer skin part so as to adjust the dimension of the outer diameter and the shape after the completion of the burning step. In this case to form the newly outer skin part, it is possible to increase the strength of the outer surface of the ceramic honeycomb structure body 1 and thereby possible to prevent occurrence of deformation and broking the cell walls 11 formed and exposed on the outer peripheral surface of the ceramic honeycomb structure body 1. Still further, the above case to coat the outer surface with the newly outer skin part can increase an isostatic strength of the ceramic honeycomb structure body 1.

In the formation of the newly outer skin part, an outer skin material is firstly coated on the worked surface 101 of the ceramic honeycomb shaped body 10. The outer skin material is a cement material or a cordierite raw material. The cement material is composed of ceramic aggregate material and a binder agent.

In the former case, the drying step is performed at room temperature and the additional drying is then performed at a temperature 500° or less in order to form the outer skin part after the outer peripheral surface of the ceramic honeycomb shaped body 10 is coated with the ceramic material.

On the other hand, in the latter case, the outer peripheral surface of the ceramic honeycomb shaped body 10 is coated with the cordierite and the additional burning step is performed.

Both the above cases produce the ceramic honeycomb structure body 1 with the outer skin part.

Still further, it is acceptable to coat the worked surface 101 of the ceramic honeycomb shaped body 10 with the outer skin material before the burning step, and to perform the burning step in order to form the outer skin part.

The produced ceramic honeycomb structure body 1 by the above manufacturing method of the first embodiment is made by the ceramic composed mainly of cordierite. The outer diameter thereof is within a range of 100.0 to 400.0 mm, and the longitudinal length thereof is within a range of 80.0 to 400.0 mm, the thickness of each cell wall 2 is within a range of 0.2 to 0.45 μm, and a cell pitch of the cells is within a range of 1.2 to 1.5 μm.

Next, a description will now be given of the action and effects of the manufacturing method of producing the ceramic honeycomb structure body 1 of the first embodiment.

The manufacturing method of producing the ceramic honeycomb structure body of the first embodiment performs the working step after the drying step. In this working step, the cutting tool 2 having the cutting tooth 21 formed at the front part thereof is moved relatively toward the axis direction of the ceramic honeycomb shaped body 10 in order to cut and remove the outer peripheral part of the ceramic honeycomb shaped body 10. That is, because the manufacturing method performs the working step to work the ceramic honeycomb shaped body 10 after the completion of the drying step, it is possible to work a specified shape of the outer peripheral part of the ceramic honeycomb shaped body 10 by using a simple tool such as the cutting tool 2 for blanking. This increases the dimensional precision of the ceramic honeycomb structure body 10.

In addition, the working step removes the outer peripheral part including the outer peripheral skin part 13 from the ceramic honeycomb shaped body 10 and the following burning step burns the ceramic honeycomb shaped body 10 without the outer peripheral skin part 13. Because it is thereby possible to prevent the occurrence of deformation and cracks to be caused by the outer peripheral skin part 13 during the burning step, the dimensional precision of the ceramic honeycomb structure body 1 finally produced is thereby increased. Further, because the rising rate of the temperature in the burning step is also increased and the total time of the burning step is accordingly decreased, it is possible to increase the manufacturing efficiency of the ceramic honeycomb structure body 1.

Still further, the extrusion molding step produces the ceramic honeycomb shaped body 10 having the outer peripheral skin part 13. The working step removes the outer peripheral skin part 13 from the ceramic honeycomb shaped body 10 in order to work a specified shape of the ceramic honeycomb shaped body 10. Accordingly, it is not necessary for the extrusion molding step to produce the ceramic honeycomb shaped body 10 having the finally produced shape. In other word, it is possible to freely determine the shape of the ceramic honeycomb shaped body 10, that is, the extrusion molding step produces the ceramic honeycomb shaped body 10 with a rough shape unless the following working step cannot work the produced one.

It is thereby possible to form a simple shape of the ceramic honeycomb shaped body 10 and to increase the manufacturing productivity thereof. Further, according to the present invention, even if there is a demand to produce plural ceramic honeycomb structure bodies of approximately same size, but of plural different types, the manufacturing method of the present invention is not necessary to produce plural types of the ceramic honeycomb -shaped bodies, that is, the extrusion molding step can produce the ceramic honeycomb shaped bodies of only one type, and the working step then works them so as to obtain the plural different shapes of the worked ceramic honeycomb shaped bodies. This feature can increase the manufacturing efficiency.

In the steps before the working step, that is, in the extrusion molding step, the cutting step, and the drying step, even if a defect such as deformation or a crack occurs in the outer peripheral skin part 13 of the ceramic honeycomb shaped body 10, it is possible to produce the ceramic honeycomb structure bodies 1 at a high precisely because the working step is capable of cutting and removing the outer peripheral skin part from the ceramic honeycomb shaped body 10.

Further, the working step in the manufacturing method according to the first embodiment performs a blanking process by using the cutting tool 2 whose cross section in a circumference direction is a ring shape or a circular shape in order to cut and remove the outer circumference part from the ceramic honeycomb shaped body 10. It is therefore possible to easily work a specified shape of the ceramic honeycomb shaped body 10 and to more increase the dimensional accuracy of the ceramic honeycomb structure body 1 produced after the burning step.

Still further, because the easy working performs the simple blanking process to cut out the outer peripheral part of the ceramic honeycomb shaped body 10 by using the cutting tool 2 for blanking, it is possible to increase the manufacturing efficiency of the ceramic honeycomb structure body 1.

Moreover, because the included angle α (or a nose angle) of the front part 211 of the cutting tool 2 is 25° (α=25°) and the clearance angle β thereof is 3° (β=3°), it is thereby possible to work the ceramic honeycomb shaped body 10 with high accuracy.

Further, because the working step uses an ultrasonic vibrating apparatus by which the cutting tool 2 for blanking is moved while vibrating the cutting tool 2 in the axis direction of the ceramic honeycomb shaped body 10, it is thereby possible to work the ceramic honeycomb shape body 10 efficiently with high accuracy. It is also possible to have the same effect by vibrating the cutting tool 2 in the circumference direction of the ceramic honeycomb shaped body 10.

Because the cutting tooth 21 of the cutting tool 2 is made of high speed steel as high strength material, the cutting tooth 21 has a high wear resistance and it is thereby possible to increase the lifetime of the cutting tooth 21 of the cutting tool 2. Further, it is possible to improve the wear resistance and the lifetime of the cutting tooth 21 by performing a surface treatment such as ceramic coating of Ti—N or Cr—N. It is further acceptable to use die steel and other material.

As described above, the first embodiment provides the manufacturing method to easily produce a specified shape of the ceramic honeycomb structure body with highly dimensional precision.

FIG. 6 is a sectional enlarged view showing another shape of the front part of the cutting tool 2 for use in blanking as shown in FIG. 2.

The manufacturing method of the first embodiment uses the cutting tool 2 for use in blanking, which has the front part 211 whose clearance angle (or an angle of relief) β is 3° (β=3°).

However, the present invention is not limited by this shape. For example, as shown in FIG. 6, it is possible to use another shape of the cutting tool 2 whose clearance angle (or an angle of relief) β is zero (β=0°).

Like the cutting tool 2 shown in FIG. 3, the cutting tool having the clearance angle (β=0°) shown in FIG. 6 can also easily work the ceramic honeycomb shaped body 10 before performing the burning step and can produce a specified shape of the ceramic honeycomb shaped body 10.

However, as shown in FIG. 6, when a cross section of the cutting tooth 21 of the cutting tool 2 in the peripheral direction is a simple circular shape, it is preferred to have the parameter L/2d within a range of 0.05 to 0.15 (0.05<=L/2d<=0/15), where L is a length of a straight shaped part 212 having the clearance angle β=0° of the front part 211, and d (omitted from FIG. 6) is a radius of the front part 211. By using the cutting tool having such a configuration, it is further possible to work the ceramic honeycomb shaped body 10 more precisely.

FIG. 7A to FIG. 7D are sectional views showing various cross sections of the ceramic honeycomb shaped body 10 in a circumference direction thereof after the completion of the working step using the cutting tool 2 in the manufacturing method of the first embodiment.

FIG. 7A, FIG. 7B, FIG. 7C, and FIG. 7D show an oval shaped cross section of, a race-track shaped cross section of, a triangle shaped cross section of, and a polygonal shaped cross section of, namely, an optional asymmetric shaped cross section of the ceramic honeycomb shaped body 10.

By setting the cross sectional shape of the cutting tooth 21 of the cutting tool 2 in advance, it is possible to form various cross sectional shapes of the ceramic honeycomb shaped body 10, and thereby possible to produce the various shaped ceramic honeycomb structure bodies..

Still further, it is possible to produce a complicated shape of the ceramic honeycomb structure body by combining plural cutting tools having various different shapes.

Second Embodiment

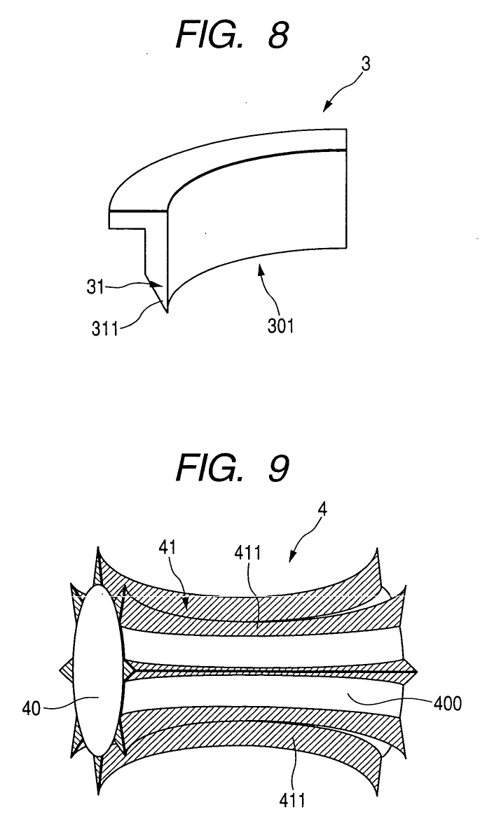

A description will be given of the manufacturing method of producing a ceramic honeycomb structure body according to the second embodiment of the present invention with reference to FIG. 8.

FIG. 8 is a perspective view showing a part of a structure of a cutting tool 3 to be used in the working step according to the second embodiment of the present invention;

As shown in FIG. 8, the cutting tool 3 to be used in the working step of the second embodiment has a curve shaped cutting tooth 31 formed at a front part 311 of the cutting tool 3. The front part 311 of the cutting tooth 31 has an acute angled shape.

Next, the manufacturing method of the second embodiment using the cutting tool 3 will be explained.

In the working step to perform a blanking process (namely, cutting and removing), the cutting tool 3 is moved in the axis direction from the upper position of the ceramic honeycomb shaped body 10 toward its bottom position while contacting the cutting tooth 31 of the cutting tool 3 to the ceramic honeycomb shaped body 10, the outer peripheral part and the outer skin part 13 of the ceramic honeycomb shaped body 10 is gradually cut and removed. This operation is repeated a plurality of times in order to obtain a specified shape of the ceramic honeycomb shaped body 10.

Similar to the first embodiment, in order to avoid the occurrence of falling down and breaking the cell walls 11 exposed on the worked surface 101 of the ceramic honeycomb shaped body 10, the blanking (namely, cutting and removing) is carried out while adjusting the force applied to the ceramic honeycomb shaped body 10.

Because the operation of other steps such as the extrusion molding step, the cutting step, the drying step, and the burning step in the manufacturing method of the second embodiment is the same of those of the first embodiment, the explanation thereof is omitted here.

Further, similar to the manufacturing method of the first embodiment which uses the cutting tool 2, it is possible to produce a specified shape of the ceramic honeycomb shaped body 10 before the burning process. It is thereby possible to easily obtain the ceramic honeycomb structure body 1 with more accuracy.

The manufacturing method of the second embodiment has the same action and the same effect of the manufacturing method of the first embodiment.

Further, it is preferred to use a cutting tool having a straight shaped cutting tooth 31 formed at the tip 301. This case to use such a cutting tool is possible to have the same action and effect described above.

Still further, it is preferred to perform the working step while arranging the plural cutting tools 3 around the ceramic honeycomb shaped body 10. This case can perform the working step of cutting and removing it more efficiently. This can further increase the manufacturing efficiency of producing the ceramic honeycomb shaped body 10.

Moreover, it is preferred to move the cutting tool 3 in the axis direction or the circumference direction of the ceramic honeycomb shaped body 10 to be worked while forcedly vibrating its cutting tool 3 by an ultrasonic vibration apparatus (omitted from the drawings), for example.

This can accurately and effectively produce the ceramic honeycomb structure body 1.

Like the first embodiment, the manufacturing method of the second embodiment can also perform the working step by using the cutting tool 3 having the clearance angle of β=0°.

When the cutting tooth 31 of the cutting tool 3 has a simple circle (or arc) shape, it is preferred to have the relationship L/2d=0.05 to 0.15 (0.05<=L/2d<=0/15), where L is a length of a straight shaped part having the clearance angle β=0° of the front part 311, and d (which is omitted from FIG. 8) is a radius of the front part 311. By using the cutting tool having such a configuration, it is further possible to work the ceramic honeycomb shaped body 10 with more accuracy. Satisfying this relationship can work the ceramic honeycomb shaped body 10 with high accuracy.

In the second embodiment, the clearance angle β (or the angle of relief) means the angle between the inner surface of the front part 311 and the moving direction (or a cutting direction) of the cutting tooth 31 of the cutting tool 3.

Third Embodiment

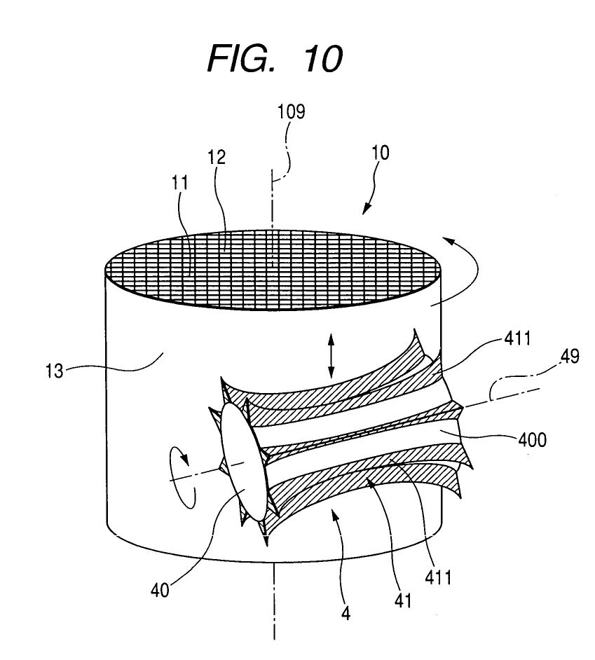

A description will be given of the manufacturing method of producing a ceramic honeycomb structure body according to the third embodiment of the present invention with reference to FIG. 9 and FIG. 10.

FIG. 9 is a perspective view showing a structure of a rotary cutting tool 4 to be used in the working step in the manufacturing method according to the third embodiment of the present invention.

FIG. 10 is a schematic view showing cutting a ceramic honeycomb shaped body 10 in the working step by using the rotary cutting tool 4 shown in FIG. 9.

The manufacturing method of the third embodiment uses the rotary cutting tool 4 shown in FIG. 9. The rotary cutting tool 4 has a base body 40 and plural cutting tooth 411 formed on the outer peripheral surface of the base body 40.

A description will now be given of the manufacturing method, which uses the rotary cutting tool 4, of producing the ceramic honeycomb structure body 10 according to the third embodiment of the present invention.

In the working step, the cutting tool 4 is so set that the axis line 49 of the rotary cutting tool 4 and the axis line 109 of the ceramic honeycomb shaped body 10 are in a twisted relationship to each other. The rotary cutting tool 4 is rotated around the axis line 49 and moved in the axis direction of the ceramic honeycomb shaped body 10. The ceramic honeycomb shaped body 10 is also rotated in the axis line 109 simultaneously. While contacting the cutting tooth 411 of the rotary cutting tool 4 to the ceramic honeycomb shaped body 10, the outer peripheral part including the outer skin part 13 is cut and removed. It is thereby possible to produce a specified shape of the ceramic honeycomb structure body 1.

Similar to the first and second embodiments, in order to avoid the occurrence of falling down and breaking the cell walls 11 exposed on the worked surface 101 of the ceramic honeycomb shaped body 10, the blanking is carried out while adjusting the force to be applied to the ceramic honeycomb shaped body 10.

Moreover, in the above explanation, although the rotary cutting tool 4 is moved and the ceramic honeycomb shaped body 10 is fixed in position while the working step is carried out, it is acceptable to move only the ceramic honeycomb shaped body 10 and to fix the rotary cutting tool 4, or also acceptable to move both the ceramic honeycomb shaped body 10 and the rotary cutting tool 4.

Because the operation of other steps such as the extrusion molding step, the cutting step, the drying step, and the burning step in the manufacturing method of the third embodiment is the same of those of the first embodiment, the explanation thereof is omitted here.

Because the axis line 49 of the rotary cutting tool 4 and the axis line 109 of the ceramic honeycomb shaped body 10 are in a twisted position to each other, and the stress generated by the rotation of the rotary cutting tool 4 is applied in a direction near the axis line 109 to the ceramic honeycomb shaped body 10, the possibility of falling down the cell walls 11 becomes small. It is therefore possible to avoid the occurrence of damage or breakage of the cell walls 11 and to obtain the ceramic honeycomb structure body 1 with a high dimensional precision.

In the third embodiment, it is so placed that the axis line 49 of the rotary cutting tool 4 is placed in parallel to a surface which is perpendicular to the axis line 109 of the ceramic honeycomb shaped body 10, namely, the inclined angle of the axis line 49 to the axis line 109 is slightly inclined to 90°, not to just 90°. This placement can obtain a more wide area of the ceramic honeycomb shaped body 10 to be contacted to the rotary cutting tool 4. This can reduce the moving distance of the rotary cutting tool 4 in the working step, and thereby reduce the working time.

In addition to the above effect, the manufacturing method of the third embodiment has the same action and the same effect of the manufacturing method of the first embodiment.

Still further, in the manufacturing method of the third embodiment, it is also possible to perform the working step while arranging the plural rotary cutting tools 4 around the ceramic honeycomb shaped body 10. This case can also perform the working step, namely, to cut and work it more efficiently. This manner can increase the manufacturing efficiency to produce the ceramic honeycomb shaped body 10.

Still further, in the third embodiment, the rotary cutting tool 4 has the base body 40 and the plural cutting members 41 made of the plural cutting tooth 411. The present invention is not limited by this construction. It is possible to use the rotary cutting tool having grinding stones formed on the outer peripheral surface of the base body 40 in order to cut and work the ceramic honeycomb shaped body 10. It is also possible to make the rotary cutting tool composed of the base body 40 and the cutting members made of only grinding stones.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A manufacturing method of producing a ceramic honeycomb structure body, comprising steps of:
extrusion molding of extruding ceramic raw material to mold a ceramic honeycomb molded body composed of an outer peripheral skin part, cell walls arranged in the outer peripheral skin part in a honeycomb structure shape, and a plurality of cells surrounded by the cell walls, each cell having a penetrate hole, penetrating both ends of the ceramic honeycomb molded body, formed along the axis direction of the ceramic honeycomb molded body;
cutting the ceramic honeycomb molded body into a plurality of ceramic honeycomb shaped bodies of a specified length;
drying the ceramic honeycomb shaped body;
working of cutting out and removing the outer peripheral surface including the outer peripheral skin part of the ceramic honeycomb shaped body by using cutting means that has a cutting tooth formed at a front part of the cutting tool while relatively moving the cutting tool in the axis direction of the ceramic honeycomb shaped bodies; and
burning the worked ceramic honeycomb shaped body.

2. The manufacturing method according to claim 1, wherein the cutting means to be used in the working step is a cutting tool for blanking which has a cutting tooth of a circular shape and whose cross section in its circumference direction corresponds to the specified shape of the ceramic honeycomb structure body, and the cutting tool cuts and removes the outer peripheral part of the ceramic honeycomb shaped body in the working step.

3. The manufacturing method according to claim 1, wherein the cutting means to be used in the working step is a cutting tool having a cutting tooth of one of a straight line shape and a curved line shape, and the cutting tool cuts out and removes the outer peripheral part of the ceramic honeycomb shaped body in the working step.

4. The manufacturing method according to claim 3, wherein the working step is performed while arranging a plurality of the cutting tools on the peripheral part of the ceramic honeycomb structure body.

5. The manufacturing method according to claim 1, wherein a clearance angle β at a front part of the cutting means to be used in the working step is within a range of more than 0° to not more than 10° (0°<β<=10°).

6. The manufacturing method according to claim 2, wherein a clearance angle β at a front part of the cutting tool to be used in the working step is within a range of more than 0° to not more than 10° (0°<β<=10°).

7. The manufacturing method according to claim 1, wherein a clearance angle β at a front part of the cutting means to be used in the working step is zero (β=0°).

8. The manufacturing method according to claim 2, wherein a clearance angle β at a front part of the cutting tool to be used in the working step is zero (β=0°).

9. The manufacturing method according to claim 7, wherein a cross section of a cutting tooth in the cutting means to be used in the working step in its circumference direction is a circular shape, and the cutting means satisfies that a parameter L/2d is within a range of 0.05 to 0.15 (0.05<=L/2d<=0.15), where L is a length of a straight shaped part of the cutting means having the clearance angle β=0° of the front part, and d is a radius of the front part.

10. The manufacturing method according to claim 8, wherein a cross section of a cutting tooth in the cutting tool to be used in the working step in its circumference direction is a circular shape, and the cutting tool satisfies that a parameter L/2d is within a range of 0.05 to 0.15 (0.05<=L/2d <=0.15), where L is a length of a straight shaped part of the cutting tool having the clearance angle β=0° of the front part, and d is a radius of the front part.

11. The manufacturing method according to claim 1, wherein an included angle α at a tip of the cutting means to be used in the working step is within a range of 5° to 55° (5°<=α=55°).

12. The manufacturing method according to claim 1, wherein in the working step, the cutting means is relatively moved in the axis direction and the circumference direction of the ceramic honeycomb shaped body while vibrating the cutting means.

13. The manufacturing method according to claim 1, wherein in the working step, the cutting means is vibrated by an ultrasonic vibration apparatus.

14. The manufacturing method according to claim 1, wherein the cutting means to be used in the working step is a rotary cutting tool composed of a base body and one of cutting member and grinding member formed on the outer peripheral surface of the base body, and the rotary cutting tool is placed on the ceramic honeycomb shaped body to be worked so that the rotary cutting tool and the ceramic honeycomb shaped body are in a twisted position each other, the working step uses the rotary cutting tool while rotatably moving the rotary cutting tool on the ceramic honeycomb shaped body.

15. The manufacturing method according to claim 14, wherein the working step uses the rotary cutting tool composed of the cutting member having a plurality of cutting tooth.

16. The manufacturing method according to claim 14, wherein the working step uses the rotary cutting tool composed of the grinding member having grinding stones.

17. The manufacturing method according to claim 14, wherein the working step uses a plurality of the rotary cutting tools placed on the outer peripheral surface of the ceramic honeycomb shaped body.

18. The manufacturing method according to claim 14, wherein in the working step, the outer peripheral part of the ceramic honeycomb shaped body is cut and removed by the rotary cutting tool rotatably moved in the axis direction of the ceramic honeycomb shaped body while rotating the ceramic honeycomb shaped body.

19. The manufacturing method according to claim 1, wherein after the completion of the working step, the outer peripheral surface of the worked ceramic honeycomb shaped body obtained by the working step is coated with an outer skin material, and the burning step is performed for making a new outer skin part on the fired ceramic honeycomb shaped body.

20. The manufacturing method according to claim 1, wherein after the completion of the burning step, the outer peripheral surface of the fired ceramic honeycomb shaped body is coated with outer skin material, and one of the burning step and the drying step is performed for making a newly outer skin part on the ceramic honeycomb shaped body.
